(19) United States
(12) Patent Application Publication
(10) Pub. No.: US 2008/0104704 A1
(43) Pub. Date: May 1, 2008

(54) SECURITY FOR PHYSICALLY UNSECURED SOFTWARE ELEMENTS

(76) Inventor: Ravikumar Mohandas, San Diego, CA (US)

Correspondence Address: KYOCERA WIRELESS CORP., P.O. BOX 928289, SAN DIEGO, CA, 92192-8289, US

(21) Appl. No.: 11/553,806

(22) Filed: Oct. 27, 2006

(51) Int. Cl. H04N 7/16; H04L 9/32; G06F 17/30; G06F 7/04; H04L 9/00; G06K 9/00; H04K 1/00; H03M 1/68

(52) U.S. Cl. 726/26; 726/27; 705/51

(57) ABSTRACT

An apparatus and method for protecting keys and similar critical software elements from unauthorized access, when the software may be exposed (unprotected). Disclosed is the use of a system clock and timer used in conjunction with critical code sections that allows the software to detect when it is being traced in an unauthorized manner. Additionally disclosed is the use of a dedicated timer which, in conjunction with code that is used to retrieve critical software elements, enables the code to trigger a system reset if the code is being run on an emulator.

### TECHNICAL FIELD

The present disclosure relates to the field of software security. More specifically, the disclosure relates to both apparatus and methods usable to greatly increase the difficulty of retrieving key software elements from code located in a device which cannot be physically secured, or where the code itself cannot be physically secured.

### BACKGROUND

There are innumerable devices in use throughout the world that use software internally, usually in the form of target (compiled) code linked to form an executable image. Some of those devices can be physically secured, such as surveillance processing equipment used to store and analyze images from remote sensors. Others cannot, such as mobile communications devices.

Intrinsically, devices which cannot be physically secured can be attacked by hackers in ways not possible with physically secured devices. These vulnerable devices can be dismantled and, after exposing the hardware on which the software runs, can be attacked in various ways. One attack is to use troubleshooting ports such as I2C bus ports connected to JTAG buffers on the main processor board. Code can be traced during execution and buffer contents read. Another is to copy or extract the device's memory content and run the code on a simulator, allowing the executable code to be traced and targeted information to be extracted.

Although it is always a concern to protect code in a product, the recent rise in the use of keys to enable certain features, and the keeping of ID and other sensitive information in specified fields in the code, has created a particular need to provide protection for physically small but very important bit sequences. Currently available protection is through the use of special memory or other added hardware. These hardware-based solutions are both too expensive and not flexible enough for products that have limited product life-spans, are very cost-sensitive, and/or have limited time-to-market requirements.

### SUMMARY

The system and methods disclosed herein are usable to protect software elements from unauthorized discovery or disclosure. “Software element” is used to mean any string of bits that requires above-normal protection from unauthorized viewing or discovery. A particularly common example is a key that is used to decode, decrypt, or authorize the use of software or data files. However, the disclosed protection mechanisms and methods are applicable to any set of bits needing extra protection, including ID information for a person or a device.

Attacks on software to gain unauthorized access is called unauthorized disclosure herein. Unauthorized disclosure includes a person attacking the device if they have physical control of the device, or attacking the code if they have a copy of the code and are attempting to run the code on an emulator. In the former case, the attack will usually be an attempt to trace code while the code is running on the device. This will usually take the form of using a troubleshooting port and the JTAG capabilities of the on-board chips. In the later case, an unauthorized person has somehow gained control of a code image for a device, and is attempting to run the code on an emulator. In each case, the underlying goal is the same: to trace the code and capture software elements of value.

The software element to be protected is stored someplace in the memory of the device. “Memory” includes any and all forms of memory usable in or with the device, and may be read-only or read-write. Although the software elements to be protected are usually in main memory or read-only memory in the device, the software elements may also reside on removable memory or may be accessed remotely.

A set of instructions (function, routine, etc.) is written to gather the stored data and generate, or recover, the software element from the fetched data. This software element retrieval software is called the key retrieval code (KRC) herein. It is to be understood that the code making up the KRC may or may not be recognizable as a distinct set of instructions or presenting a single interface in the code base of the device. The lines of code making up the functionality of the KRC may be quite diffuse, and purposefully so, in order to further confound an unauthorized trace attempt. Further, portions of the KRC may reside in places such as ISRs (interrupt service routines) as well as in the traditional code base organized as functions or routines. Thus, it is to be understood that “KRC” and similar concepts, as used herein, includes any and all code wherever located in the system or its components, used to carry out the functions described as belonging to the KRC.

Protection of software elements is given herein in a number of embodiments and can be implemented as combinations of those embodiments. Included is the use of two timers. One type of timer uses the system clock (an undedicated source of timing information), and the other type of timer is based on a watchdog timer (a dedicated timer able to reset the system). The KRC is used in conjunction with one or both timers to confound code tracing; multiple instances of the timers may be used as well.

The system-clock-based timer is used to check the time delta when executing memory fetches, or lines of code. If the code is being traced using JTAG or similar technology, the amount of time it takes to execute instructions is noticeably increased. Comparing the actual time delta (time to complete a specified action) with a projected maximum time delta while the KRC is executing, enables detection that the code is being traced. The time calculation may be implemented as a time difference variable, a count-down timer, or other method. Once the trace condition is detected during execution of the critical code, the KRC may return a false value, no value, cause the system to reset, or take other actions.

The watchdog timer is used in two ways. In one embodiment, the watchdog timer value is set so that under normal (non-tracing) circumstances, the KRC will finish executing before the timer value indicates the watchdog timer should send a reset to the CPU. A watchdog timer usually issues a system reset as a result of a buffer or counter overrun; the buffer needs to be periodically reset to 0 to show proper operation of executing code. In another embodiment, the watchdog timer and the KRC share a common read-write area (a shared variable, buffer, etc.) in addition to a timer value. This is used to tie the executing KRC and the watchdog timer together in such a way that the KRC, rather than the watchdog timer, can determine when to send a CPU reset command. This is explained more fully below.

Additionally, other embodiments showing ways of using indirect coding and its effects to further hide the KRC from an unauthorized code tracer are disclosed. It is intended that the disclosed exemplar embodiments be combined as needed for each implementation.

### BRIEF DESCRIPTION OF THE DRAWINGS

FIG. 1 illustrates exemplar devices.

FIG. 2 is a block diagram of exemplar software for the devices.

FIG. 3 is a flow diagram for protecting software elements from unauthorized disclosure.

FIG. 4 is a set of flow diagrams illustrating further embodiments for protecting software elements from unauthorized disclosure.

FIG. 5 is a state diagram showing watchdog timer usage for protecting software elements from unauthorized disclosure.

FIG. 6 is a flow diagram showing watchdog timer usage for protecting software elements from unauthorized disclosure.

### DETAILED DESCRIPTION

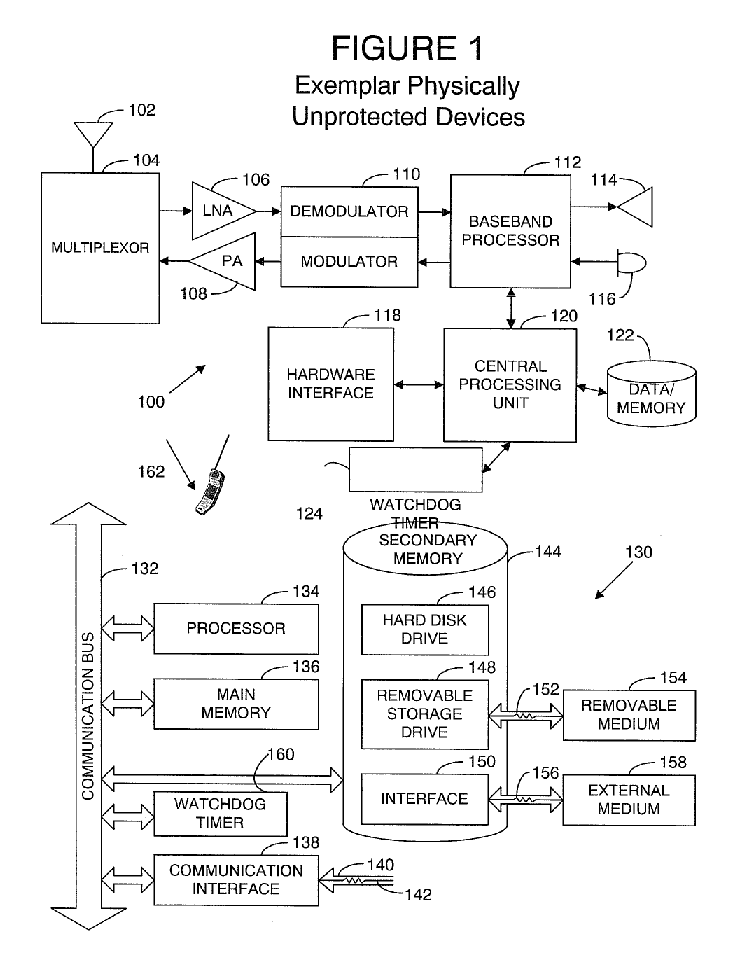

Persons of ordinary skill in the art will realize that the following description of the present invention is exemplary and not in any way limiting. Other embodiments of the invention will readily suggest themselves to such skilled persons who also have the benefit of the present disclosure. Referring generally to the drawings, for illustrative purposes the present invention is shown embodied in FIG. 1 through FIG. 6. It will be appreciated that the apparatus may vary as to configuration and as to details of the parts, and that the method may vary as to details and the order of any acts, without departing from the inventive concepts disclosed herein.

The word “exemplary” or “exemplar” is used to mean “serving as an example, instance, or illustration.” An embodiment described as “exemplary” or as an “exemplar” is not necessarily to be construed as preferred or advantageous over other embodiments.

The term “computer readable medium” is used to refer to any media used to provide, hold, or carry executable instructions (e.g., software, computer programs) usable for execution by a central processing unit (CPU, microprocessor, DSP, or any other logic device capable of executing instructions). Media includes, but is not limited to, memory readable by the CPU that can be local, remote, volatile, non-volatile, removable, etc., and can take any suitable form such as primary memory, secondary memory including disks, removable cards or flash, remote disks, etc. Computer readable medium further includes any means for providing executable code, programming instructions, and/or decision inputs to a CPU used in a wireless communication device, base station, or other entity with a CPU. The executable code, programming instructions, decision inputs, etc., when executed by a CPU is used to cause the CPU to enable, support, and/or perform the inventive features and functions described herein.

FIG. 1 includes a block diagram illustrating an exemplary wireless communication device 100 that may be used in connection with the various embodiments described herein. It is an example of a physically unprotected device. As used in this disclosure, “physically unprotected” means any device where a potential attacker or hacker has physical access to the physical device, for whatever reason or by any means, allowing at least some examination of the code in the device by some means. The concept also includes any way in which an attacker can obtain the contents of memory containing, or a copy of, the code having the data to be protected. For example, if an unauthorized person obtained access to a code server inside of a company where the code server is physically secure, but was still able to obtain a copy of the code used in a device, the concept of “physically unprotected” or “unprotected” applies. In the later case the code has become unprotected, being available for a hacker to probe using an emulator or other means.

Wireless communication device 100 may be a handset, PDA, wireless network device, or a sensor node in a wireless mesh network. All other wireless communication devices are fully contemplated herein.

Wireless communication device 100 comprises an antenna 102, a multiplexor 104, a low noise amplifier (“LNA”) 106, a power amplifier (“PA”) 108, a modulation circuit 1100, a baseband processor 112, a speaker 114, a microphone 116, a central processing unit (“CPU”) 120, a data storage area 120, and a hardware interface 118. In the wireless communication device 100, radio frequency (“RF”) signals are transmitted and received by antenna 102. Multiplexor 104 acts as a switch, coupling antenna 102 between the transmit and receive signal paths. In the receive path, received RF signals are coupled from a multiplexor 104 to LNA 106. LNA 106 amplifies the received RF signal and couples the amplified signal to a demodulation portion of the modulation circuit 110.

Typically modulation circuit 110 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 112.

If the base-band receive audio signal contains audio information, then base-band processor 112 decodes the signal and converts it to an analog signal. Then the signal is amplified and sent to the speaker 114. The base-band processor 112 also receives analog audio signals from the microphone 116. These analog audio signals are converted to digital signals and encoded by the base-band processor 112. The base-band processor 112 also codes the digital signals for transmission and generates a base-band transmit audio signal that is routed to the modulator portion of modulation circuit 110. The modulator mixes the base-band transmit audio signal with an RF carrier signal generating an RF transmit signal that is routed to the power amplifier 108. The power amplifier 108 amplifies the RF transmit signal and routes it to the multiplexor 104 where the signal is switched to the antenna port for transmission by antenna 102.

The baseband processor 112 is also communicatively coupled with the central processing unit 120. The central processing unit 120 has access to a memory and data storage area 122. The central processing unit 120 is configured to execute instructions (i.e., computer programs or software) that can be stored in the data storage area 122. Computer programs can also be received from the baseband processor 112 and stored in the data storage area 122 or executed upon receipt.

The central processing unit may also be configured to receive notifications from the hardware interface 118 when new devices are detected by the hardware interface. Hardware interface 118 can be a combination electromechanical detector with controlling software that communicates with the CPU 120 and interacts with new devices.

Watchdog timer 124 is an additional hardware device, typically located on the same board as CPU 120. It can access certain common buffers with the CPU, and can issue CPU reset commands which restarts the entire system (reboots the system).

Communications device 100 is located in a housing, an exemplar handset housing illustrated as 162. The properties of a housing are simply to provide a mounting point for the physical components described above (and below, for system 130), and providing the form factor and protection of the internal components from dirt, water, shock, etc., in accordance with its intended use. Clearly, a notebook computer would have a different housing than cell phone, but they share the housing's properties of mounting the components in/on a physical structure, where the structure meets the needs of the device's intended use. A portable or mobile device is one where the housing and its components mounted therein are designed to be carried by a person, or moveable by a person. Examples include handsets, notebook computers, PDAs, household WiFi routers, modems, etc.

Computer system 130 is an exemplar system found in devices including PCs, copiers, sound decoding and playing devices, etc., usable with the protection mechanisms disclosed herein.

System 130 includes one or more processors or logic units, such as processor 134. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 134.

Processor 134 is connected to a communication bus 132. Communication bus 132 may include a data channel for facilitating information transfer between storage and other peripheral components of computer system 130. Communication bus 132 will normally be comprised of a set of signals used for communication with the processor 134, including a data bus, address bus, and control bus (not shown). Communication bus 132 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 130 includes a main memory 136 and may also include a secondary memory 144. Main memory 136 provides storage of instructions and data for programs executing on processor 134. Main memory 136 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 144 may optionally include a hard disk drive 146 and/or a removable storage drive or port 148, for example a floppy disk drive, a magnetic tape drive, a compact disc (“CD”) drive, a digital versatile disc (“DVD”) drive, or a solid state memory form factor. The removable storage drive 148 reads from and/or writes through media interface 152 to a removable storage medium 154. Removable storage medium 154 is of the type compatible with drive or port 148, for example, a floppy disk, magnetic tape, CD, DVD, solid state memory of various kinds and form factors, etc.

Computer system 130 also has a watchdog timer 160, which has the ability to check a value that the CPU can reset (through its programming). If the watchdog timer value reaches a predetermined threshold then it will issue a CPU reset command, which restarts the system.

Computer system 130 may also include a communication interface 138. Communication interface 138 allows software and/or data to be transferred between computer system 130 and external devices and/or sensors, and if applicable, networks or other information sources. Examples of communication interface 138 include a modem, a network interface card (“NIC”), a serial or parallel communications port, a PCMCIA slot and card, an infrared interface, and an IEEE 1394 fire-wire, just to name a few.

Connectivity is achieved through communication channel 140 receiving input signals 142 (may also comprise output signals to the sensors and/or devices). Communication channel 140 carries signals 142 implemented using a variety of communication means including wire or cable, fiber optics, conventional phone line, cellular phone link, radio frequency (RF) link, or infrared link, just to name a few.

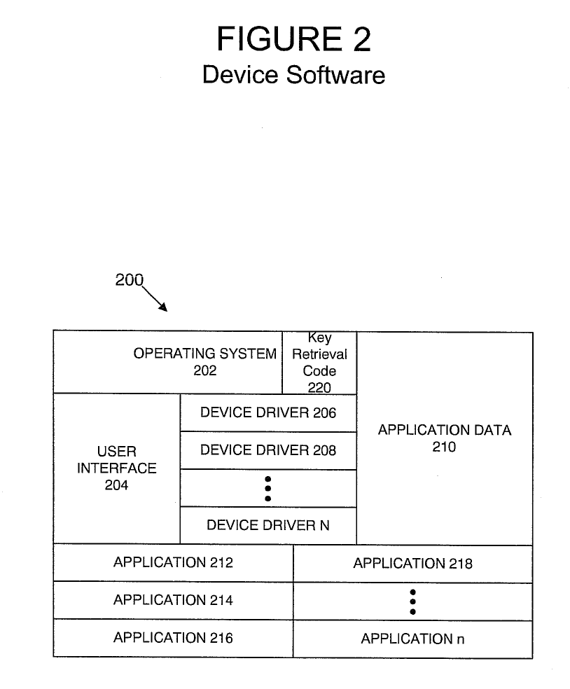

FIG. 2 is a block diagram of exemplar software (or code) 200 in a device as discussed in FIG. 1. In the illustrated embodiment, operating system 202 comprises the fundamental executable program or programs that allow the device to function. In addition to operating system 202, the software comprises application data 210 and user interface 204. Application data 210 comprises user information and application information that an application needs to function or that an application uses to provide its service.

User interface 204 may comprise both the executable user interface application and the user interface data that is used by a UI application. In an alternative embodiment, the user interface application portion may be included as part of the operating system and the user interface 204 may comprise ancillary user data or custom data or other data usable by the user interface application or the user. Software or code 200 will usually additionally comprises one or more device drivers such as device driver 206, device driver 208, all the way up to device driver n. These device drivers comprise executable code that facilitate communication between software running on or in operating system 202 and various components in communication with operating system 202, such as a display, keypad, speaker, microphone, earphones, data sensors, to name a few.

Additionally shown are a set of software applications or modules such as applications 212, 214, 216, 218, up to application n. As illustrated, a large number of applications may comprise part of the software or code in a device. The only limit on the number of applications is the physical limit of available storage in the device.

Also shown is Key Retrieval Code (KRC) 220. Shown as part of the OS layer, it could be an application level program depending on the design of the system as a whole. The KRC is the set of instructions that retrieves software elements from memory so as to provide the maximum amount of protection to those elements, as described more fully below.

Applications, including but not limited to music decoders, often require keys in order to run or operate on applicable data, such as encoded or encrypted music files. The key(s) associated with an application is/are the bit sequence(s) to be protected from unauthorized discovery and use, not the entire application or data file. Likewise, unique ID sequences, keys, or other bit/byte sequences (rather than entire sections of code or large amount of data) which are used to authorize or enable use of applications, to gain access to information, or used to convert data or code into a useable form, are the software elements the present disclosure is designed to protect. Although a typical key, bit sequence, byte sequence, word sequence, or other software element (collectively referred to as either “keys” or “software elements” herein) may be on the order of 1-8 bytes long, there is no specific upper or lower limit on the size of a key or protectable software element usable with the methods and apparatus disclosed herein. The keys may be located in the OS, in the system data, in application code, or in other places throughout the code base.

The methods and apparatus disclosed herein may also be used to protect short code sequences that encompass trade secrets or sensitive data manipulation techniques, as well as keys. They may also be used to protect relatively short sequences of any type of sensitive data.

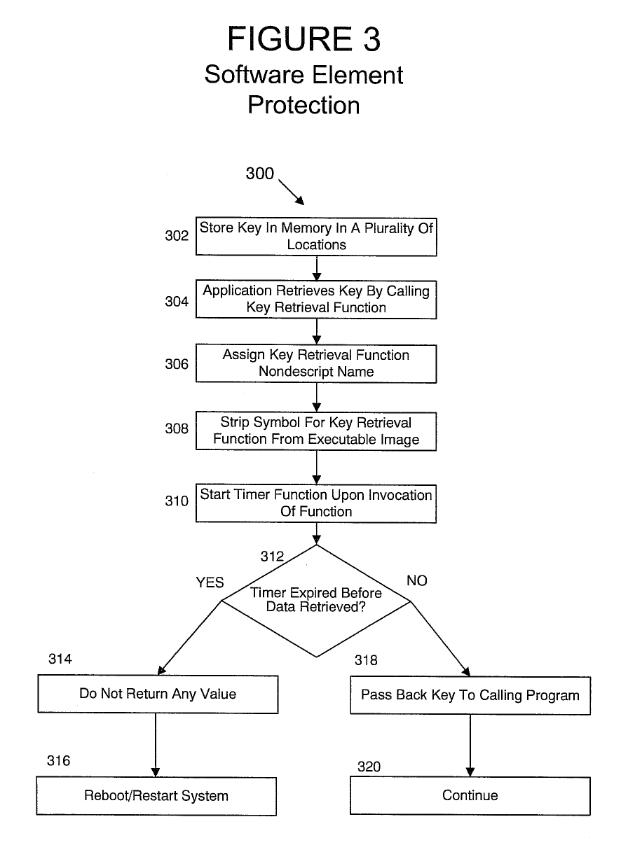

FIG. 3 illustrates an exemplar sequence and design for protecting software elements. Flow chart 300 represents a set of methods usable to protect keys. In addition to the descriptions in FIG. 3, combinations may be made with elements from the subsequent figures as well.

Box 302 represents an initial phase where the key is dived into a subset of itself, and those subsections are then stored at various locations in memory. This is done to protect keys from being found by simply scanning memory. Keys (software elements) will often have recognizable patterns that enable them to be found by scanning all the data and code (all memory locations) in memory. Thus, the first step is to never store the key in its final form. The key may simply be divided up into a number of bytes or words and stored in disparate sections of memory. They may also be positionally combined with arbitrary sequences to further hide any recognizable patterns. For example, if the memory in the device is addressable (stored) in 16-bit units, a 64-bit key could broken up into 8 8-bit sequences and stored in 8 memory locations. Each 16-bit memory location would have the remaining 8 bits padded with another 8 bits, used to reduce the recognizability of the protected sequence. When retrieved, the padding bits are simply stripped away. The padding may be any method, such as alternating a random bit between each protected bit, adding a word before or after the protected word, or any other way which allows recovery of the desired bit sequence.

Box 302 thus represents both the design features of the code (the design of the key storage mechanism into a plurality of memory locations), and the actions using the design method. The actions are those associated with retrieving the data from the correct memory locations, and then putting together the information to retrieve the key.

Box 304 represents calling or using the code that retrieves the key from its plurality of stored locations in memory. The OS or application code that needs to use the key will not be able to retrieve the key from its dispersed locations directly. This allows the memory locations to be kept in a single code sequence to prevent them from being proliferated, and to keep the padding algorithm as unknown as possible. Thus, the code needing the key calls a key retrieval function. The key retrieval function will know the memory locations to read, and the padding or other obscuring methods used (if any) of the stored key sections. The function will recover the key sections from a plurality of memory locations, pull the right bits out and put them together to and return a retrieved key, as needed for a particular embodiment.

Box 306 represents the use of a non-descript function or routine name. For example, when a function is named that is to be used for key retrieval, it should not be named “key_retrieval” or anything similar. A hacker will be looking for descriptive names that occur at certain points in the application or OS where a key or ID is needed. Upon finding one or more suspect names, the hacker could simply watch for the function to be invoked and capture the returned value (the key). Thus, if a function call is used to retrieve keys, the function name should be an arbitrary alphanumeric sequence.

Box 306 thus represents both the design features of the code, and the actions associated with using the design. The design is to use a non-descript name for the function. The actions are those associated with calling the function with any needed parameters using the designated non-descript name.

Box 308 represents a further step to prevent detection of the key retrieval code. After the executable image is generated, the symbol for the key retrieval function may be stripped out of any tables. This simply leaves a jump of some kind to an address, which is harder for a hacker to detect as a significant event. Box 308 thus represents the actions taken during the build of an executable image, and represents the calling of a key retrieval function using an instantiated symbol during execution, where the symbol table does not have the symbol for this function listed.

Each of the above descriptions are usable for creating executable images that make it hard for a hacker to recognize a key retrieval function call, or key retrieval code sections, by scanning the image. If is preferable to use as many of these techniques as possible, but they are not required. All, some, or none may be used as determined for each application or embodiment.

Box 310 represents the use of a timer as part of the key retrieval algorithm. When the key retrieval function is called (preferably after being obscured from easy detection as described above, but that is not a requirement), the function uses a timer as it retrieves the key from memory. The description in this figure is a software-only solution, that is, the timer used is the system timer, not a dedicated timer. The key retrieval function reads the system clock just before it starts retrieving portions of the key from different memory locations. The code then generates one or more time deltas, depending on the embodiment, until either a predetermined maximum time delta is reached or the key sections are in local memory. A time delta is a measure or indicator of elapsed time.

If the maximum time delta is reached first, the retrieval code either sends a system restart command (used in devices like cell phones when the system is in an unknown state), or sets some kind of flag or indicator to the OS that prevents further processing. This protects against the use of troubleshooting ports to trace code execution. When tracing code, the time taken to execute is significantly longer than when no tracing is occurring. The system or board clock still runs at normal speed, so it can be deduced that if retrieval time takes longer than a certain amount over what is normally expected, there is a serious system problem or the software is being watched as it executes (traced). In either case, once the maximum delta is detected the key will not be retrieved and/or retuned. Note that any way of using the system clock signal may be used. For example, the timer may simply be a count-down timer (steps a local timer down to 0 based on clock or timing signals rather than calculating a time delta). Any way of using a system clock signal is fully contemplated.

Continuing with diamond 312, the time delta is checked against the data retrieval event. If the timer indicates too much time has passed before the key data is retrieved or processed or both, then the “YES” branch is taken to box 314.

Box 314 corresponds to the actions taken to halt the retrieval process and/or to not returning a value to the caller of the function. Continuing into box 316, the system is restarted. Boxes 314 and 316 represent one response to the use of a timer while retrieving a key. Either box's associated actions may be used alone, or in combination. For example, the code may be written so that immediately upon detection of the timer being expired, the system is restarted. This would add significant confusion to anyone tracing code, and would greatly increase the time and difficulty to isolated what was happening. However, other of the indicated actions may be taken as well. For example, the retrieval function could simply return a non-functioning value, or branch or otherwise transfer execution to other code when the timer event occurs. Any of these possible responses to the state reflected in box 314 are fully contemplated herein.

If, at diamond 312, the timer has not expired when the key portions have arrived, the “NO” exit is taken to box 318. The actions associated with box 318 include those needed to pass the key to the calling routine. Box 318 is then left for box 320, which represents continuation of the normal code execution past key retrieval.

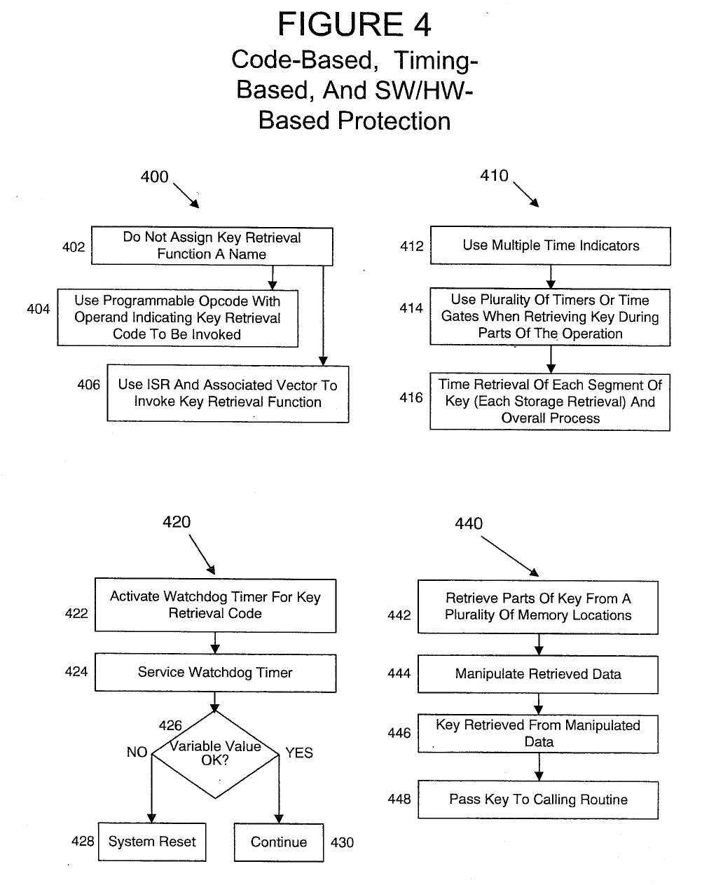

FIG. 4 illustrates further embodiments usable in conjunction with the overall flow shown in FIG. 3. 400 illustrates embodiments using no function call to invoke the key retrieval code; 410 illustrates embodiments using multiple timers; and, 420 illustrates embodiments using a specific hardware timer to subvert the use of emulators to capture returned from call retrieval functions or code. Each of these embodiments may be used separately or in conjunction with each other. 440 illustrates the flow for regenerating a key from memory.

400, the use of no function call, starts at box 402. The key retrieval code is not assigned a function name, and is not invoked using a function call. Continuing into box 404, one embodiment is to use a programmable opcode. The opcode takes user-definable parameters. The parameters include an indication of where the KRC is (what code to execute). Thus, box 404 represents both a design choice (use of user-defined opcodes) and a flow, the flow including the actions taken when the code that needs to retrieve a key will invoke the retrieval code by using the opcode with the designated parameter. This is an alternate embodiment to boxes 304-308 in FIG. 3.

Alternatively, box 400 may be embodied using box 404. Box 404 represents the design choice and actions associated with using an ISR and its associated vector to invoke the key retrieval software. The vector associated with an ISR is set to point to the key retrieval code. When a key needs to be retrieved, the calling code issues a software interrupt. The interrupt service routine services the interrupt by looking up the associated vector. The vector points to the key retrieval code; the code is executed. This means the key retrieval code has no function call associated with it, which further hides the code from hackers (a further level of indirection). Like box 402, this would be embodied by replacing boxes 304-308 in FIG. 3 with the actions and design choices just described.

Embodiments using 410, multiple timers, are generally shown at box 412. Multiple timers may be implemented using the actions associated with box 414. Instead of a single timed operation corresponding to the key's retrieval from memory, the key generation process is further subdivided into time-measurable sub-actions. These may also overlap in physical time (the timers may be running simultaneously). The actions corresponding to box 414 are to initialize any needed timers when the key retrieval code is started. Continuing into box 416, each timer is triggered at each predetermined timed event. Timed events include, but are not limited to, time to retrieve all portions of the key, time to process the retrieved data, and time to retrieve each individual key portion. Multiple timers would be initialized as part of the actions associated with box 310 in FIG. 3; each timer is handled as described in 312-320 in FIG. 3, once started. The first timer of any of the multiple timers to expire would be considered a timing failure, and would trigger the desired failure modes (system restart or other actions).

420 illustrates an embodiment where a hardware timer, a watchdog timer, is used with the key retrieval software. The timer is a dedicateable hardware resource, and would be dedicated to the retrieval code while the retrieval code is running. This differs from the timer described in FIG. 3 which is the general system clock, not a dedicated resource. Using a dedicated resource in the manner shown in FIG. 4 creates confusion during unauthorized code tracing because it generates system resets for no apparent reason (not directly correlated with a specific place in the code currently being traced).

Box 422 corresponds to the actions associated with setting or activating a watchdog timer. This may be at the start of the key retrieval code, or may be done prior to calling the key retrieval software. This activation, or reset of the timer to 0, may be made more obscure by hiding it amongst other code being executed as a result of an ISR. Since the watchdog timer operates separately from the code being executed, it will be difficult to tell it is being used. Continuing into box 424, the actions correspond to two general approaches. One, the watchdog timer max value is set to a high enough value so that the key retrieval code should finish under normal circumstances before it runs down to 0; upon completion the timer is either deactivated or reset. Two, the watchdog max value is set so that the key retrieval code must reset it as the key retrieval process is being run. Either comprises servicing the watchdog timer.

Resetting the watchdog counter may be accomplished by a direct call, or indirectly through the use of an ISR. In most cases it would be preferable to use the ISR method, to create further indirection.

Continuing into diamond 426, the ISR handling the watchdog timer interrupts checks the value of the watchdog timer against the max value. If it is exceeded, the value is not OK and the “NO” exit is taken to box 428. The actions associated with box 428 are those needed to reset the system. If the value is OK, the “YES” exit is taken to box 430, where normal code execution continues, and logically it loops back into itself (diamond 426) until the time is deactivated or the value is exceeded. Other embodiments are not shown; for example, some watchdog timers work by creating buffer or counter overruns after the designated time period, where the overrun generates an interrupt resulting in a system reset. Any embodiment of a watchdog timer is contemplated herein.

Process 440 is a closer look at the flow associated with key retrieval (box 310 in FIG. 3). When the key retrieval code or function is called, the actions associated with box 442 are carried out. The memory locations which contain portions of the key are read, and the data is made available to the key retrieval code. It is expected that these memory locations would not be contiguous, but they may be. The locations are a design choice made by the implementers. Continuing into box 444, the actions associated with this box are any and all needed to manipulate the data read from memory. This could be as simple as stripping out alternate bits from each word, dropping every other word, or similar. It may also include the use of more sophisticated algorithms to regenerate portions of the key. Continuing into box 446, the actions correspond to those needed to finish deriving or extracting the full key from the manipulated data. This may be as simple as concatenating portions of the previously manipulated data together, or my be more sophisticated manipulations. Finally, box 448 is entered. The derived, regenerated, or otherwise determined key from box 446 is provided to the code that called the key retrieval code. There is no limitation on how the key may be passed back. It may be the return value of a function call, loaded into a mutually accessible buffer or variable, or otherwise made available to the calling code.

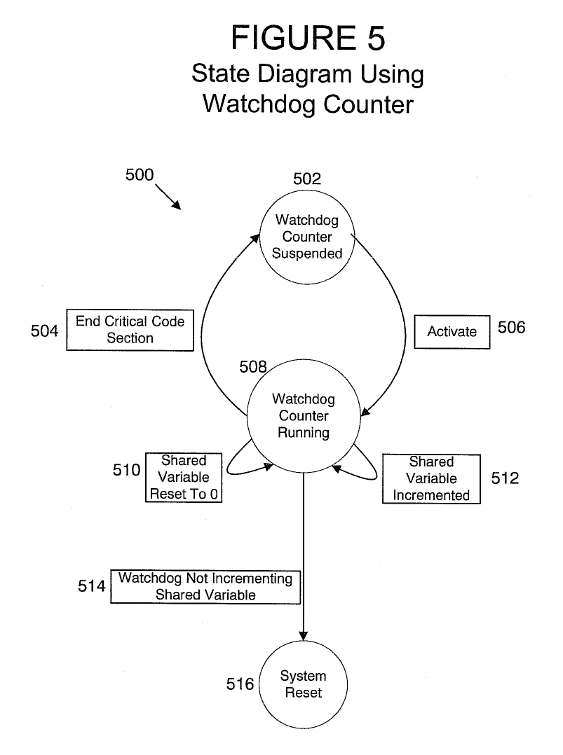

FIG. 5 is a state diagram (500) showing an embodiment where a watchdog counter is used to help defeat the unauthorized use of an emulator to retrieve software elements. Using the system clock as in FIG. 3, or the watchdog counter as shown in FIG. 4 at 420, helps defeat unauthorized code tracing while the code resides on the device hardware; it cannot be used to detect unauthorized code tracing when the entire image is being run on an emulator. The emulator will provide an emulated clock signal, so the time delta being measured in FIG. 3 will appear correct. Further, the emulator will not have the watchdog counter shown in FIG. 4 at 420, so no system reset will be triggered.

502 represents a watchdog timer in an inactive state. As part of starting the key retrieval code the watchdog timer is activated (506). The activation may occur before or after the call to start the key retrieval process, but preferably occurs before the memory fetches begin. The watchdog counter is now running (508). While the watchdog counter is running, the key retrieval code is also running on the CPU. There is a shared variable, buffer, or other read/write area accessible by both the watchdog counter ISR and the key retrieval code (or its ISR).

As the watchdog runs, it periodically invokes its associated ISR on the CPU. The ISR increments the value in the shared variable each time (512). It may also be configured to run the process described in FIG. 4, 420, at the same time; that is, the two logical flows will both be occurring. As the key retrieval code is executing, it periodically checks the value of the shared variable. This may be done directly, but directly checking the shared area may be too easy to detect when someone is tracing the code. An alternate method is to check the shared variable indirectly through the use of an ISR. When the key retrieval code sends an interrupt which is handled by that ISR, the ISR checks to see if the value of the timer has incremented to or past a certain value. If it hasn't, that means something has kept the variable from incrementing (514), such as the code being run on an emulator.

The failure to increment results in the key retrieval ISR trigging a system reset (516). If the shared variable is being incremented properly, the ISR triggered by the key retrieval code resets the shared variable to 0 (510). The watchdog ISR continues to increment the shared variable, and the key retrieval code periodically checks the value in the shared variable. This logical loop continues until the of the critical code section (504). At that point the watchdog timer is deactivated (502), or, is made available for other processes or to a default system check process.

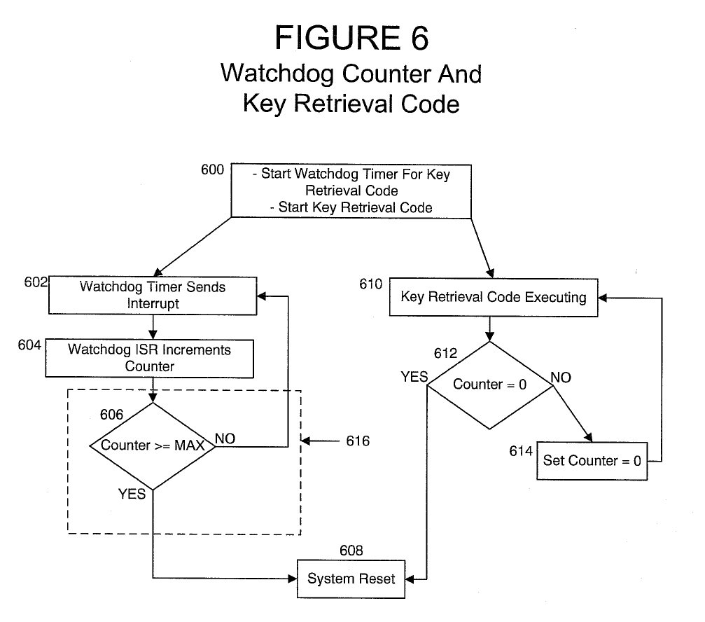

FIG. 6 is a flow diagram showing the use of a watchdog timer in conjunction with execution

of the KRC. Box 600 corresponds to the actions taken to start both the KRC and the watchdog timer. The watchdog timer and the KRC both have read-write access to a common area, called a counter in this figure. The counter shown in diamond 606 and in diamond 612 refer to the same counter. The watchdog timer and the KRC execute simultaneously.

Continuing into box 602, the actions taken include the watchdog timer sending an interrupt to the main processor, which invokes an ISR. Box 604 is then entered, corresponding to those actions taken by executing the ISR. This includes incrementing the counter. Box 604 is left for diamond 606.

Diamond 606 is shown enclosed by dotted-lines 616. This indicates that a further embodiment may leave this decision out, in which case the watchdog timer would simply increment the counter each time the ISR is invoked. In an embodiment using diamond 606, the counter is checked to see if it's value exceeds a MAX value. The MAX value is set to leave enough time to allow the KRC to either complete or have reset the counter to 0. If MAX is reached the KRC has either hung or is being traced and the “YES” exit is taken to box 608. The actions corresponding to box 608 are those needed to reset the system (restart it). If the counter is less than MAX, the “NO” exit is taken to box 602. Note that the actual implementation may vary; for example, the MAX value check may be a counter overflow. The watchdog timer loops through this sequence until it is deactivated at the end of KRC execution.

The watchdog timer is executing simultaneously with the KRC. Moving to box 610, the actions are all those taken during the KRC's execution. The KRC contains code to check the counter at different points during execution. This may be implemented in any number of ways. One preferred embodiment is to send an interrupt and let the ISR handle the counter. This provides a further level of code indirection, making it harder to detect and defeat the interconnection between the watchdog timer and the executing KRC. Another embodiment is to check the counter directly in the KRC instruction stream. Whatever way is used to implement the counter code, the functional effect is that the counter is checked to see if its value is 0. If the answer is yes, the “YES” exit is taken to box 608. The actions associated with box 608 are those taken to reset the system. This is done because of the frequency with which watchdog timers are invoked is much higher (may be orders of magnitude) than the frequency with which the counter is reset to 0 by the KRC. The counter is set to 0 at initialization and thereafter only by a reset from the KRC. If the KRC finds the counter is 0, that means the watchdog timer is not present. This indicates the code is running in an emulator.

If the counter is not 0, the “NO” exit is taken to box 614. The actins associated with box 614 include those needed to reset the counter to 0. Box 614 is then left for box 610. The loop continues until the KRC is finished executing.

From the above description of exemplary embodiments of the invention, it is manifest that various techniques can be used for implementing the concepts of the present invention without departing from its scope. Moreover, while the invention has been described with specific reference to certain embodiments, a person of ordinary skill in the art who also has the benefit of the present disclosure would recognize that changes could be made in form and detail without departing from the spirit and the scope of the inventive concepts disclosed herein. The described exemplary embodiments are to be considered in all respects as illustrative and not restrictive. It should also be understood that the invention is not limited to the particular exemplary embodiments described herein, but is capable of many rearrangements, combinations, modifications, and substitutions without departing from the scope of the invention.

What is claimed is:

1. A method for protecting software elements, the method comprising:
executing code;
determining that a key is needed by the code;
triggering execution of key retrieval code (KRC), the KRC configured to retrieve a key previously loaded into a memory, the memory accessible by the KRC;
enabling a timer usable to determine a timer value based on elapsed time;
executing the KRC;
checking the timer value;
retuning a key by the KRC to the code if the key is retrieved before the timer value reaches a predetermined value;
stopping execution of the KRC before retuning the key to the code if the timer value reaches the predetermined value.

2. The method of claim 1 further comprising storing the key in a plurality of non-contiguous memory locations in the memory.

3. The method of claim 2, where each of the plurality of memory locations has the portion of the key stored therein manipulated.

4. The method of claim 1, where stopping execution further comprises resetting the system.

5. The method of claim 1, where executing the KRC further comprises:
fetching data from a plurality of memory locations, the memory locations each storing a portion of the data needed to retrieve a key;
manipulating the fetched data; and
retrieving the key from the manipulated data.

6. The method of claim 1, where checking the timer value further comprises:
starting the timer upon starting the KRC;
checking the timer value when the KRC has fetched all the memory locations in which the key is stored.

7. The method of claim 1, where checking the timer value further comprises:
starting the timer upon starting the KRC; and
checking the timer value when the KRC has fetched a first portion of the key, when the key is stored in a plurality of memory locations.

8. The method of claim 7 further comprising:
enabling a plurality of timers, each timer associated with a value;
starting the fetching of a plurality of memory locations which together contain the key;
using a timer for each of a plurality of memory location fetches which together comprise the key memory locations; and
stopping execution of the KRC if any of the timers reach its associated value.

9. The method of claim 8 where the plurality of timers further includes a timer for the entire key fetch.

10. A method for protecting software elements, the method comprising:
executing code;
determining that a key is needed by the code;
triggering execution of key retrieval code (KRC), the KRC configured to retrieve a key previously loaded into a memory accessible by the KRC;
enabling a watchdog timer usable with the KRC;
associating a value with the watchdog timer;
executing the KRC;
checking the watchdog timer's value by the watchdog timer;
retuning a key by the KRC to the code if the key is retrieved before the watchdog timer reaches a predetermined value;
resetting the system if the watchdog timer reaches the predetermined value.

11. The method of claim 10 further comprising storing the key in a plurality of non-contiguous memory locations in the memory.

12. The method of claim 11, where each of the plurality of memory locations having a portion of the key stored therein is stored in a manipulated form.

13. The method of claim 10, where executing the KRC further comprises:
fetching data from a plurality of memory locations, the memory locations each storing a portion of the data needed to retrieve a key;
manipulating the fetched data; and
retrieving the key from the manipulated data.

14. The method of claim 10, where checking the watchdog timer value further comprises:
starting the timer upon starting the KRC;
resetting the watchdog timer value by the KRC after the KRC has fetched all the memory locations in which the key is stored.

15. The method of claim 10, where checking the timer value further comprises:
starting the timer upon starting the KRC; and
resetting the timer value when the KRC has fetched a first portion of the key, the key stored in a plurality of memory locations, before fetching a next portion of the key.

16. The method of claim 15 further comprising:
resetting the timer value after each portion of the key is fetched, the timer value having been set to a predetermined value that triggers a system reset if any one of the fetches exceeds an average fetch time by a predetermined amount.

17. A mobile device comprising:
a CPU;
a memory in operable communication with the CPU;
a system clock in operable communication with the CPU;
a watchdog timer operable to reset the CPU and to use a settable watchdog timer value (WTV), the watchdog timer configured to reset the CPU when the WTV reaches a predetermined value;
code, executable by the CPU, in the memory comprising code that requires a key and key retrieving code (KRC), the KRC configured to retrieve the key, the key stored in the memory, the KRC configured to use the system clock to determine an elapsed time value (SC ETV) and to set the WTV in a manner that increases the amount of time before the watchdog timer resets the CPU, the KRC further configured to retrieve the key and while retrieving the key to (i) check the SC ETV and to stop retrieval of the key if the SC ETV exceeds a predetermined value and to (ii) set the WTV such that if KRC code execution time exceeds a predetermined time limit the watchdog timer resets the CPU.

18. The mobile device of claim 17 where the KRC is further configured to set the WTV such that it will indicate to the watchdog timer the CPU is to be reset before the KRC finishes, and further where the KRC is configured to reset the WTV at a plurality of predetermined points during execution.

19. The mobile device of claim 17 where the KRC is further configured to determine a plurality of SC ETVs usable to time different portions of the KRC's execution.

20. The mobile device of claim 19 where portions of the key are stored in a plurality of locations making up an entire key when fetched and combined, and at least some of the plurality of SC EVTs are used to check execution time for fetching portions of the key.
